(19) United States
(12) Patent Application Publication
(10) Pub. No.: US 2006/0038884 A1
(43) Pub. Date: Feb. 23, 2006

(54) Driving monitor device

(76) Inventor: Joe Ma, N. Van. (CA)

Correspondence Address: ROSENBERG, KLEIN & LEE, 3458 ELLICOTT CENTER DRIVE-SUITE 101, ELLICOTT CITY, MD, 21043, US

(21) Appl. No.: 10/919,247

(22) Filed: Aug. 17, 2004

(51) Int. Cl. H04N 7/18

(52) U.S. Cl. 348/118

(57) ABSTRACT

A driving monitor device has an image-capture module and a storage unit. The image-capture module is set on a rear view mirror inside an automobile. The image-capture module has at least two image-capturing lenses. An electrical sensor is located behind each image-capturing lens. The image-capture module can take wide-angle images of the front side, left hand side and right hand side, outside the automobile. The storage unit is connected to the image-capture module to store the image. Therefore, when a traffic accident occurs, the image stored in the storage unit can be used as evidence.

### BACKGROUND OF THE INVENTION

1. Field of the Invention

The present invention relates to a driving monitor device, especially to an image catching device set on the rear view mirror of a vehicle. The driving monitor device can get the image of the right hind side, left hand side and the front side outside the vehicle, and store the images in a storage unit. When an accident occurs, the image data can be evidence for diagnosis of the reason for an accident.

2. Description of Related Art

A rear view mirror in the modern automobile is an important device to increase the vision of the driver. The rear view mirror is bonded with a mirror and adhered to the body of a car. The vision angle and the security of the driver and passengers are the most important benefits derived from use of the rear view mirror.

The rear view mirror in the car only increases vision in a rearward direction. When a driver is driving, he cannot know all situations well outside the car. Blind spots do exist.

Unfortunately, when an accident occurs, the only evidence is the statements of witnesses and these are not necessarily accurate. Therefore, the judgment sometimes will not be correct.

### SUMMARY OF THE INVENTION

A driving monitor device is disclosed. An image-capture module is set on the rear view mirror of a vehicle. The driving monitor device can get the right hind side image, left hand side image and the front side image outside the vehicle, and store the images in a storage unit.

To achieve the object mentioned above, the present invention providing a driving monitor. device including an image-capture module, which is set on the rear view mirror of the automobile, at least two image-capturing lenses and an electrical sensor separately set behind the image-capturing lenses. A storage unit connected to the image-capture-module is set in the automobile.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings, in which:

FIG. 1 shows a three-dimensional diagram of the first embodiment of the present invention;

FIG. 2 shows a plane diagram of the first embodiment of the present invention;

FIG. 3 shows a block diagram of the first embodiment of the present invention;

FIG. 4 shows a cross-section diagram of an image-capture module of the first embodiment;

FIG. 5 shows an exercise state diagram of the image-capture module of the first embodiment;

FIG. 6 shows an exercise state diagram of the image-capture module of the second embodiment.

FIG. 7 shows the block diagram of the third embodiment of the present invention;

FIG. 8 shows the block diagram of the forth embodiment of the present invention; and

FIG. 9 shows the block diagram of the forth embodiment of the present invention.

### DETAILED DESCRIPTION OF THE INVENTION

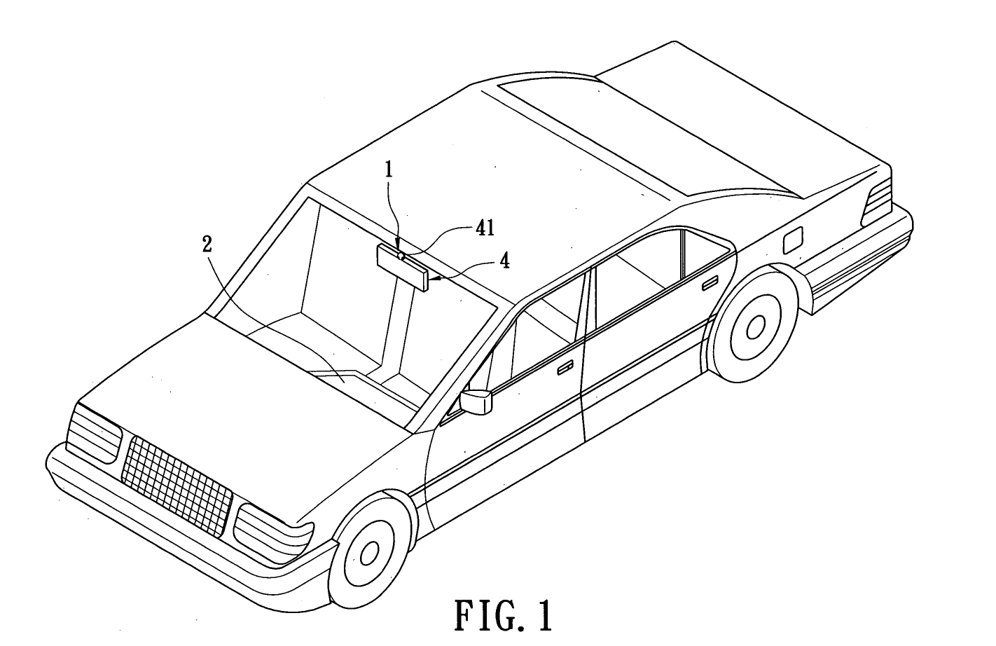

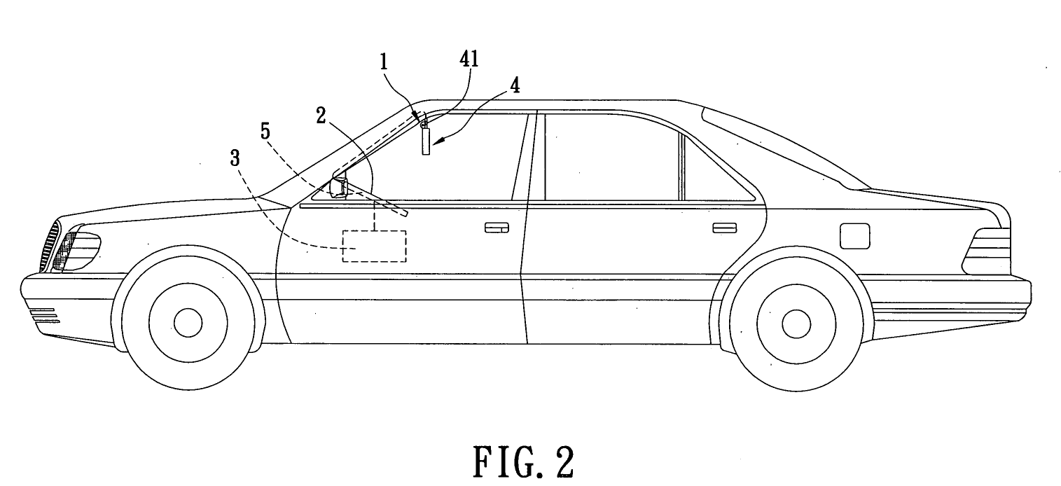

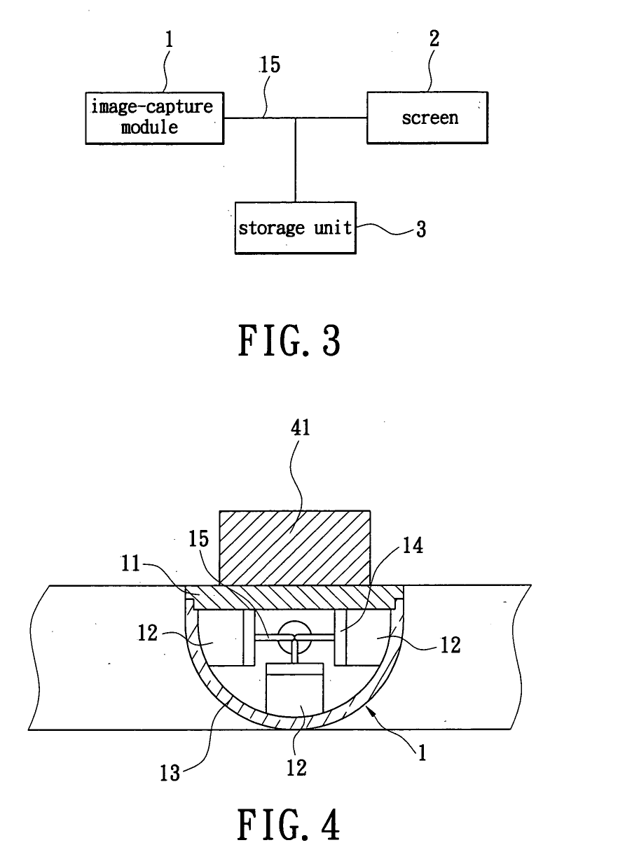

Reference is made to FIG. 1, FIG. 2 and FIG. 3. The present invention providing a driving monitor device including an image-capture module 1, a screen 2, and a storage unit 3. The image-capture module 1 comprises a shell 11. The shell 11 can be adhered, clamped, screwed or integrally formed on the holder 41 of the vehicle rear view mirror 4. Therefore, the image-capture module 1 can be fixed on the vehicle rear view mirror 4.

The three image-capturing lens 12 is set in the shell 1, as shown in FIG. 4, and the image-capturing lens 12 is directed to the front side, left hand side and right hand side of the automobile. A transparent cover 13 covers the image-capturing lens 12. The shell 11 includes three electrical sensors 14, which are the charge coupled device sensors. The electrical sensors 14 are separately set behind the image-capturing lens 12 and the electrical sensors 14 transmits image data to the screen 2 and the storage unit 3 through the signal wire 15.

The screen 2 is set on a mobile monitor 5 and connects to the image-capture module 1 and the storage unit 3. The screen 2 shows the real time image caught by the image-capturing lens 12 of the image-capture module 1. The screen 2 can also be used to browse the image data stored in the storage unit 3.

The storage unit 3 can be combined with a mobile computer system and is also connected to the image-capture module 1 and the screen 2. The storage unit 3 can store the image data caught by the image-capturing lens 12 of the image-capture module 1.

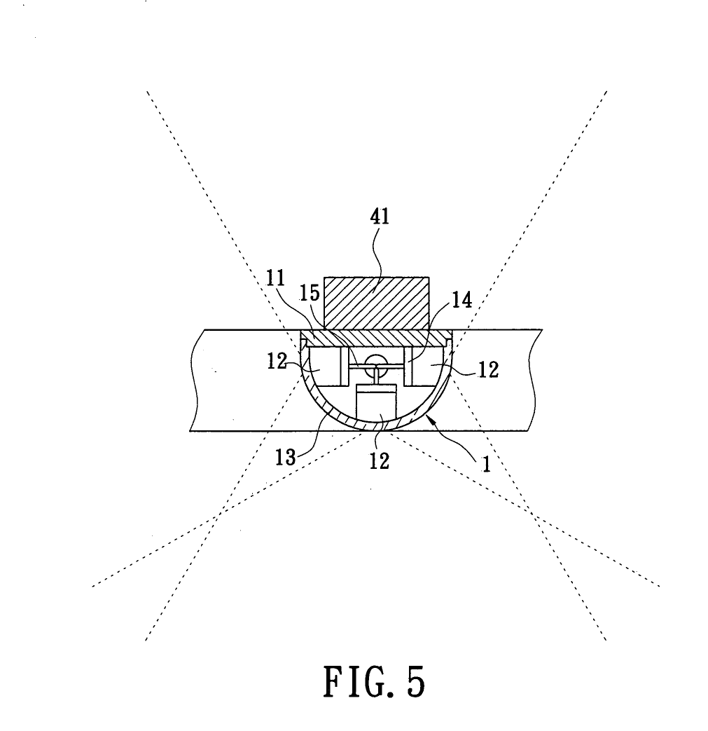

The composition mentioned above forms the driving monitor device of the present invention. The present invention sets the image-capture module 1 on the vehicle rear view mirror 4 for convenience. The three different visual angle image-capturing lens 12 can get the front side image, right hand side image and the left hand side image, as illustrated in FIG. 5. Screen 2 in the automobile can display the real time image caught by the image-capture module 1. Therefore, the present invention can eliminate blind spots and increase security while driving.

Furthermore, the storage unit 3 can store the real time image caught by the image-capture module 1. If an accident occurs, the stored data can be used as a record of the accident event.

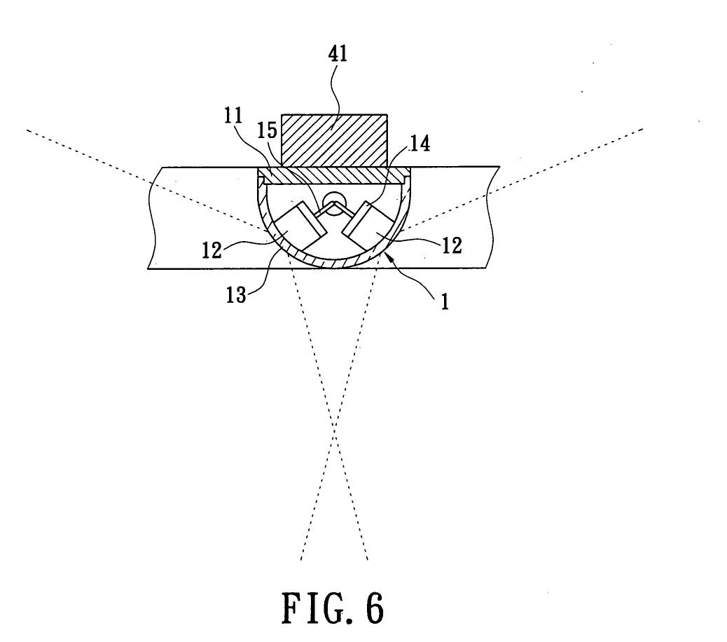

Reference is made to FIG. 6. The image-capture module 1 of the present invention can also have two image-capturing lenses 12. The two image-capturing lens 12 are wide-angle lenses. In one embodiment, the image-capture module 1 can take the front side image, left hand side image and right hand side image out of the automobile.

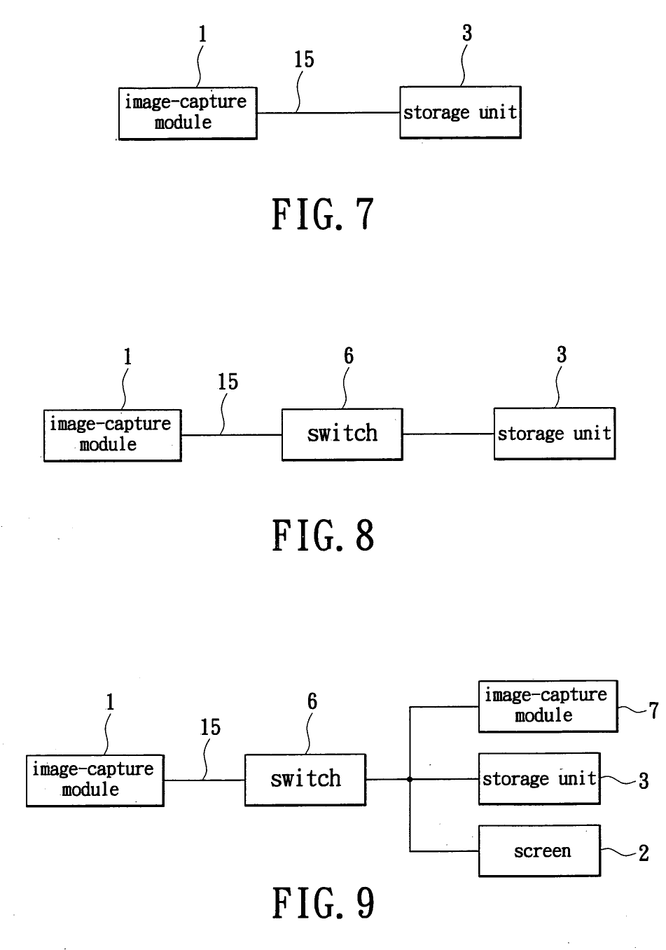

Reference is made to FIG. 7. The present invention also can reduce the screen 2. It can only use the storage unit 3 to store the image data caught by the image-capture module 1. The storage unit 3 can be a hard disk or any other storage device.

Reference is made to FIG. 8. A switch 6 connects the image-capture module 1 and the storage unit 3. The switch 6 can be set in an ON/OFF state.

Reference is made to FIG. 9. The present invention can have a secondary image-capture module 7; the secondary image-capture module 7 is fixed in an appropriate position in the automobile and facing the mobile monitor. The secondary image-capture module 7 is also connected to the storage unit 3. The secondary image-capture module 7 can catch an image inside the automobile and store the image in the storage unit 3.

Therefore, if something misfortune happens, the stored mobile monitor data can be used for determining the cause of the accident.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A driving monitor device, including:
an image-capture module comprising at least two image-capturing lenses, wherein the image-capture module is set on a rear view mirror inside an automobile, the image-capturing lenses separately face a front side, a left hand side and a right hand side of the automobile, and each image-capturing lens has an electrical sensor; and
a storage unit connected to the image-capture module and set inside the automobile.

2. The driving monitor device as in claim 1, the image-capture module is set on a holder of the rear view mirror.

3. The driving monitor device as in claim 1, the image-capture module comprising a shell, wherein the image-capturing lenses are set inside the shell, and a transparent cover covers the shell.

4. The driving monitor device as in claim 3, wherein the shell is assembled on the rear view mirror inside the automobile.

5. The driving monitor device as in claim 3, wherein the shell is integrally formed on the rear view mirror inside the automobile.

6. The driving monitor device as in claim 1, the electrical sensor is a charge coupled device sensor.

7. The driving monitor device as in claim 1, wherein a signal wire connects the image-capture module and the storage unit.

8. The driving monitor device as in claim 1, wherein a switch connects the image-capture module and storage unit.

9. The driving monitor device as in claim 1, wherein the storage unit is connected to a mobile computer system.

10. The driving monitor device as in claim 1, wherein the storage unit is a data storage device.

11. The driving monitor device as in claim 1, further comprising a screen connected to the image-capture module and the storage unit, wherein the screen is set inside the automobile.

12. The driving monitor device as in claim 1, wherein the screen is also set on a mobile monitor inside the automobile.

13. The driving monitor device as in claim 1, further comprising a secondary image-capture module, wherein the secondary image-capture module is connected to the storage unit and oriented to the mobile monitor.
